(19) United States
(12) Patent Application Publication
(10) Pub. No.: US 2016/0221837 A1
(43) Pub. Date: Aug. 4, 2016

(54) INDOOR AND OUTDOOR WATER FILTERING APPARATUS

(71) Applicants: JAM HOM CO.,LTD., Pingtung (TW); National Yunlin University of Science & Technology, Douliu (TW)

(72) Inventor: CHING-HSU CHANG, Taichung (TW)

(73) Assignees: JAM HOM CO.,LTD., PINGTUNG (TW); National Yunlin University of Science & Technology, Douliu (TW)

(21) Appl. No.: 14/612,057

(22) Filed: Feb. 2, 2015

(51) Int. Cl. C02F 1/00; C02F 1/44

(52) U.S. Cl. CPC C02F 1/002; C02F 1/441; C02F 2209/03

(57) ABSTRACT

An indoor/outdoor water filtering apparatus having a pump electrically connected to a power device supplied by an external power source or a rechargeable battery with a switch for user selection of a plurality of operating modes for filtering water in different environments, wherein a first mode electrically connects a first loop with a first pressure sensor cutting off power when water pressure exceeds an upper limit, a second mode cuts off power, and a third mode electrically connects a second loop with a second pressure sensor cutting off power when water pressure is lower than a lower limit.

### BACKGROUND OF THE INVENTION

1. Technical Field

The present invention relates to a water filtering device, and more particularly to water filtering apparatus, which is able to be mounted at indoors and outdoors.

2. Description of Related Art

A water filtering apparatus may filter impurities, pollutants, harmful substances, even virus and bacteria out through filters installed therein to get drinking water. People can drink the water coming out of the water filtering apparatus without having to boiling it again.

The conventional water filtering apparatus is huge, and has to be mounted at a specific place. It also has to connect to a pressurized water source, such as tap water, so the conventional water filtering apparatus is not available for portable. If people go out for camping or mountain climbing, they usually carry filtered water in bottles. Carrying the water is a heavy loading for a person in outdoor activity. Some people carry a portable stove to boil river water. However, the boiled river water still has a lot of impurities and harmful substances, such as heavy metal, so that it is not safe to drink the boiled river water. In some areas, such as disaster area, the shortage of tap water and electric power make the water filtering apparatus couldn't work, so it carries out another problem.

### BRIEF SUMMARY OF THE INVENTION

In view of the above, the primary objective of the present invention is to provide an indoor and outdoor water filtering apparatus, which is capable of portable for user to filter water anywhere.

In order to achieve the objective of the present invention, the present invention provides an indoor and outdoor water filtering apparatus, which is connected to a water source to filter raw water of the water source, including a frame, a filtering device, a pump, a rechargeable battery, a power device, and a switch. The filtering device has a raw water inlet, a filtered water outlet, and at least one filter, which is mounted on the frame. The raw water inlet is connected to a water source, and the at least one filter is connected to the raw water inlet and the filtered water outlet respectively to filter raw water of the water source coming in from the raw water inlet, and generates filtered water coming out via the filtered water outlet. The pump pumps the raw water of the water source to the filter of the filter device. The rechargeable battery supplies the pump with electric power. The power device includes a first power input port, a second power input port, and a power output port. The first power input port is electrically connected to the rechargeable battery, and the power output port is electrically connected to the pump. When the second power input port is connected to an external power source, electric power of the external power source is supplied to the pump through the power output port, and supplied to the rechargeable through the second power input port to charge the rechargeable. The switch is electrically connected to the power device, and has a plurality of operating modes for a user to select. The operating modes includes a first made and a second mode. The electric power is transmitted to the pump when the first mode is selected, and the electric power for the pump is cut off when the second mode is selected.

With such design, the water filtering apparatus of the present invention could be used at indoors and outdoors. Furthermore, water from any water source, such as tap water, river, and pond, could be filtered by the water filtering apparatus of the present invention anytime and anywhere.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first preferred embodiment of the present invention;

FIG. 2 is a front exploded view of the first preferred embodiment of the present invention, showing inside of the apparatus;

FIG. 3 is a rear exploded view of the first preferred embodiment of the present invention, showing inside of the apparatus;

FIG. 4 is a sketch diagram of the first preferred embodiment of the present invention, showing the water filtering system;

FIG. 5 is a block diagram of the power of the first preferred embodiment of the present invention, showing the power system;

FIG. 6 is a sketch diagram of the first preferred embodiment of the present invention, showing the apparatus operating at outdoors;

FIG. 7 is a sketch diagram of the first preferred embodiment of the present invention, showing the apparatus operating at indoors; and

FIG. 8 is a sketch diagram of a second preferred embodiment of the present invention.

### DETAILED DESCRIPTION OF THE INVENTION

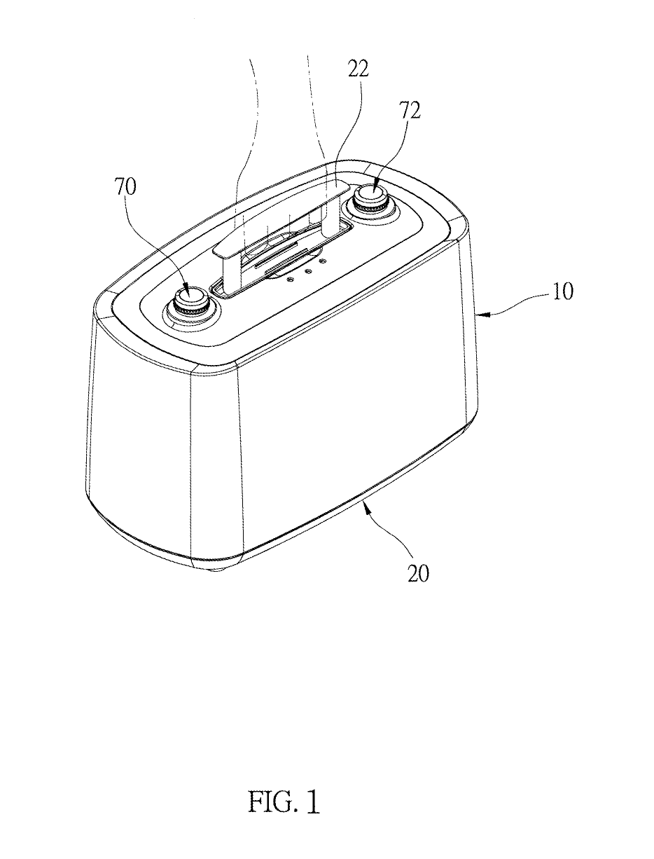

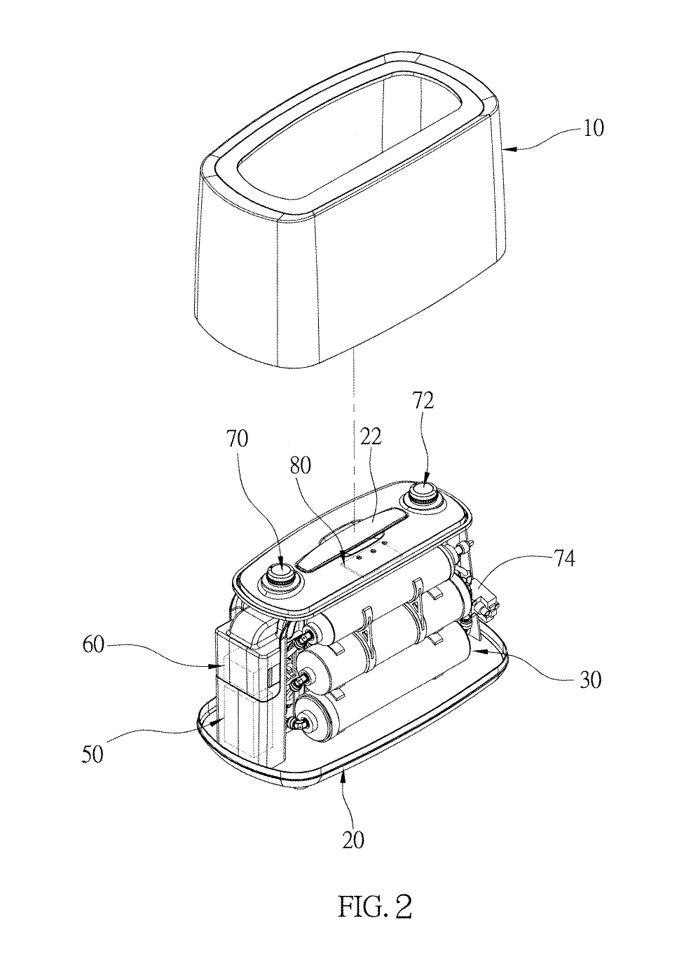

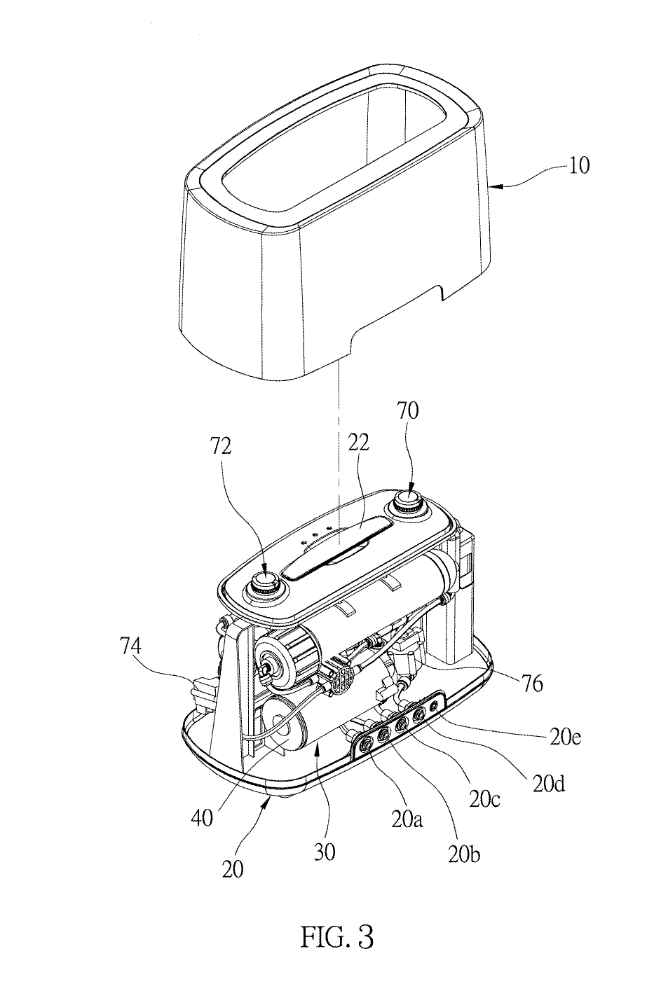

FIG. 1 to FIG. 3 show an indoor and outdoor water filtering apparatus of the first preferred embodiment of the present invention, including a housing 10, a frame 20, on which a filtering device 30, a pump 40, a rechargeable battery 50, a power device 60, a switch, a timer, a first pressure sensor, a second pressure sensor, and a displace circuit 80 are provided. In the first embodiment, the switch is a band switch 70, the timer is a time switch 72, the first pressure sensor is a high-pressure sensing switch 74, and the second pressure sensor is a low-pressure sensing switch 76.

The housing 10 receives the frame 20 and the elements on the frame 20 therein, and is connected to the frame 20 at a bottom thereof. The housing 20 is provided with a grip 22 on a top thereof for user to carry the water filtering apparatus. The frame 20 is provided with a waste water outlet 20a, a filtered water outlet 20b, a drinking water outlet 20c, and a raw water inlet 20d, all of which are adjacent to a bottom of the frame 20, and connected to the filtering device 30 respectively. The frame 20 further is provided with a power connector 20e, which is electrically connected to the power device 60.

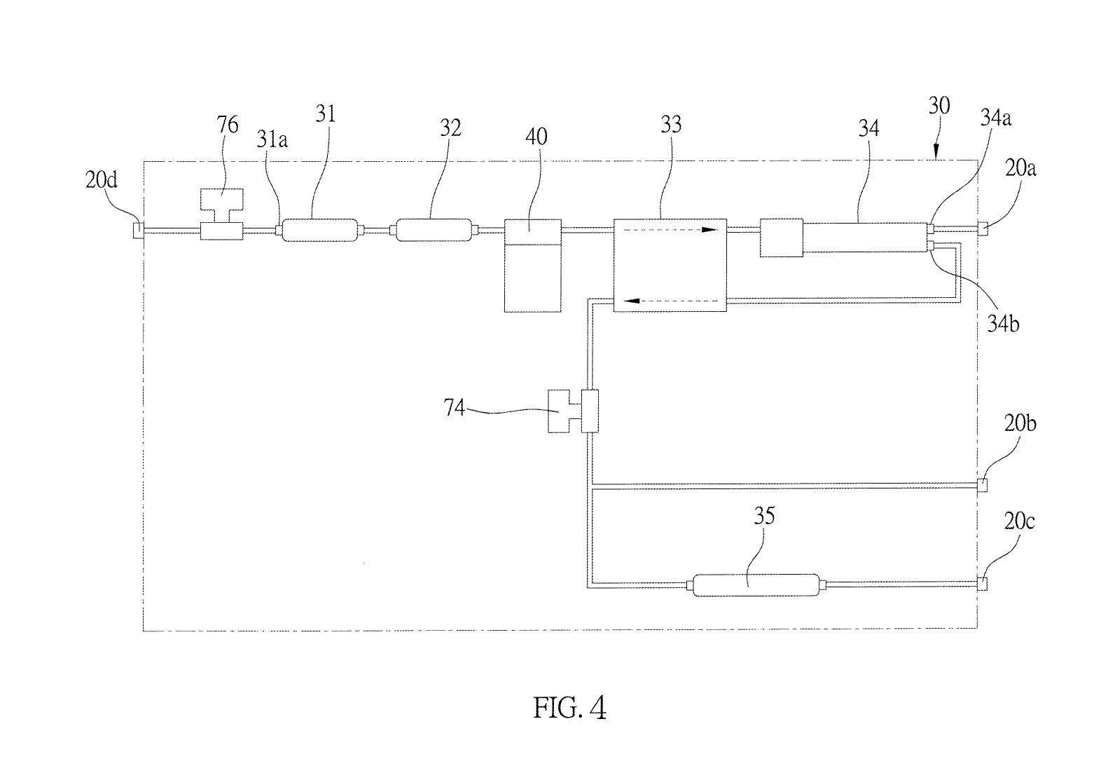

As shown in FIG. 4, to get a good filtering performance, the filtering device 30 is provided with a first front filter 31, a second front filter 32, a water switch 33, a RO (reverse osmosis) filter 34, and an activated carbon filter 35.

The first front filter 31 has a water inlet 31a, which is connected to the raw water inlet 20d to let raw water flow into the first front filter 31. In the present embodiment, the water comes from a water source, such as a faucet of tap water or a river. The pump 40 pumps the raw water of the water source to the first front filter 31 through the raw water inlet 20d. After the first front filter 31, the water keeps flowing to the second front filter 32, the pump 40, the water switch 33, and the RO filter 34 in sequence. The RO filter 34 has a first outlet 34a and a second outlet 34b, wherein the first outlet 34a is connected to the waste water outlet 20a to drain the waste water out, and the second outlet 34b is connected to the filtered water outlet 20b through the water switch 33 to output filtered water. A container (not shown) is connected to the filtered water outlet 20b to store the filtered water. The second outlet 34b is connected to the drinking water outlet 20c through the water switch 33 and the activated carbon filter 35. A valve 92, such as faucet, is connected to the drinking water outlet 20c for user to drink the water coming from the faucet directly. The low-pressure sensing switch 76 is provide on a pipe between the first front filter 31 and the raw water inlet 20d to sense a pressure of the raw water entering the first front filter 31. The high-pressure sensing switch 74 is provided on a pipe after the water switch 33 to sense a pressure of the filtered water coming out of the filtered water outlet 20b and the drinking water outlet 20c.

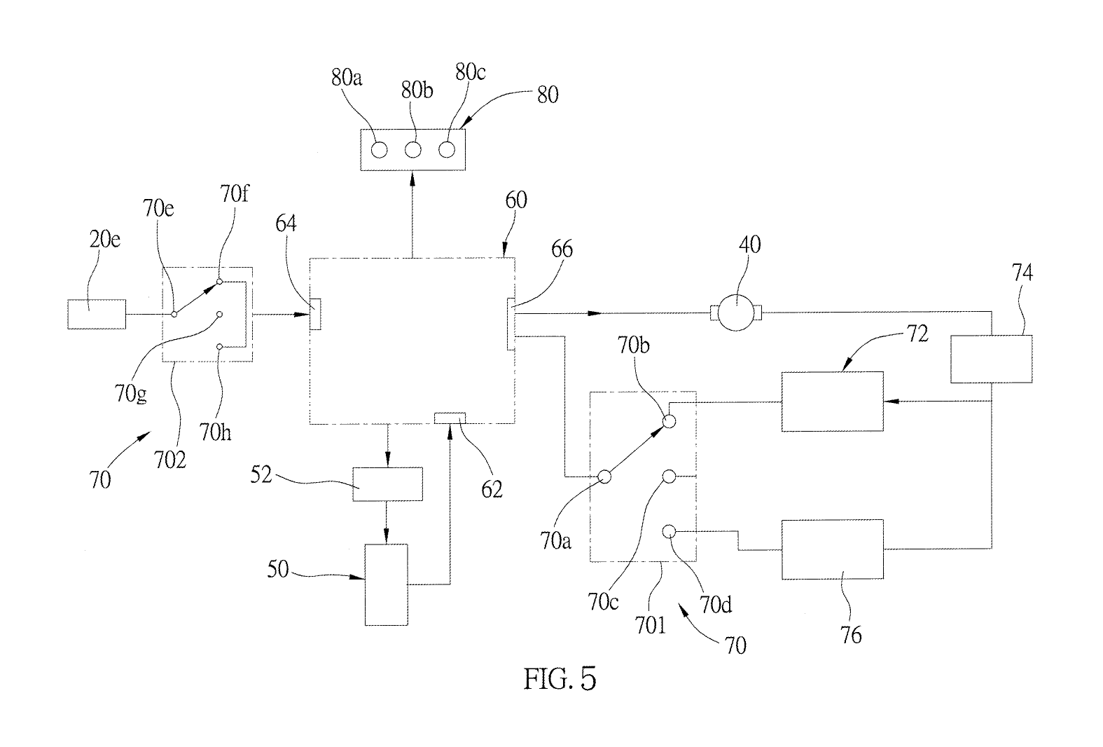

As shown in FIG. 5, the power device 60 includes a first power input port 62, a second power input port 64, and a power output port 66. The first power input port 62 is connected to the rechargeable battery 50, the second power input port 64 is connected to a connector 20e, which is able to connect to an external power source (not shown), and the power output port 66 is electrically connected to the pump 40. The power device 60 receives electric power via the first power input port 62 and/or the second power input port 64 to supply the pump 40 with electric power.

When the connector 20e is disconnected to the external power source, the rechargeable battery 50 takes place to provide electric power to the power device 60 via the first power input port 62, which means that the pump 40 is powered by the rechargeable battery 50.

When the connector 20e is connected to the external power source, the power device 60 establishes a connection between the second power input port 64 and the power output port 66 to power the pump 40 by the external power source. The power device 60 establishes a connection between the second power input port 64 and the first power input port 62 to charge the rechargeable battery 50 at the same time. In conclusion, the pump 40 is powered by the rechargeable battery 50 when the connector 20e is not connected to the external power source, and the pump 40 is powered by the external power source, and the rechargeable battery 50 is charged when the connector 20e is connected to the external power source. If the external power source supplies insufficient electric power, both the rechargeable battery 50 and the external power source together supply the sufficient electric power to the pump 40.

The band switch 70 has several operating modes for user to select, including a first mode, a second mode, and a third mode. The band switch 70 further includes a first switch member 701 and a second switch member 702, which work at the seam time. The first switch member 701 is on a line between the power output port 66 and the pump 40, and the second switch member 702 is on a line between the connector 20e and the second power input port 64. Each operating mode decides specific statuses of the first switch member 701 and the second switch member 702.

When the first mode is selected, the first switch member 701 is switched to have a connection between a common terminal 70a, which is connected to the power output port 66 of the power device 60, and a first terminal 70b, which is connected to the timer 72. The timer 72 is electrically connected to the power output port 66 through the high-pressure sensing switch 74 and the pump 40 in sequence to form a loop. The timer 72 is settable to turn the pump 40 on in a specific period when the electric power is supplied to the timer 72, and cut off the electric power for the pump 40 when time is up. The high-pressure sensing switch 74 is turned off to stop the pump 40 while the pressure of the water coming out of the second outlet 34b of the RO filter 34 is higher than an upper-limited pressure. At the same time, the second switch member 702 is switched to have a connection between a common terminal 70e, which is connected to the connector 20e, and a first terminal 70f, which is connected to the second power input port 64 of the power device 60.

In the second mode, the first switch member 701 of the band switch 70 is switched to have a connection between the common terminal 70a and a second terminal 70c, which is not connected to any element, to turn the first switch member 701 off, so that the pump 60 is stopped. At the same time, the second switch member 702 of the band switch 70 is switched to have a connection between the common terminal 70a and a second terminal 70c, which is not connected to any element, to turn the external power off.

In the third mode, the first switch member 701 is switched to have a connection between the common terminal 70a and a third terminal 70d, which is connected to the low-pressure sensing switch 76. When the third mode is selected, the electric power is transmitted to the low-pressure sensing switch 76 instead of the timer 72, and then transmitted to the high-pressure sensing switch 74, the pump 40, and the power output port 66 of the power device 60 in sequence. The low-pressure sensing switch 76 is turned off when a pressure of the raw water entering the water inlet 31a of the first front filter 31 is lower than a lower-limited pressure, so that the pump 40 is stopped. At the same time, the second switch member 702 is switched to have a connection between the common terminal 70e and a third terminal 70h, which is connected to the second power input port 64 of the power device 60, to supply the power device 60 with the electric power of the external power source.

The displace circuit 80 is electrically connected to the power device 60, and has a power light 80a, a battery light 80b, and a charging light 80c to indicate a power status of the power device 60.

When the power light 80a lights, it means that the power device 60 is working. The system is turned on.

When the battery light 80b lights, it means that the rechargeable battery 50 supplies electric power to the pump 40. The system is powered by the rechargeable battery 50.

When the charging light 80c lights, it means that the rechargeable battery 50 is being charged.

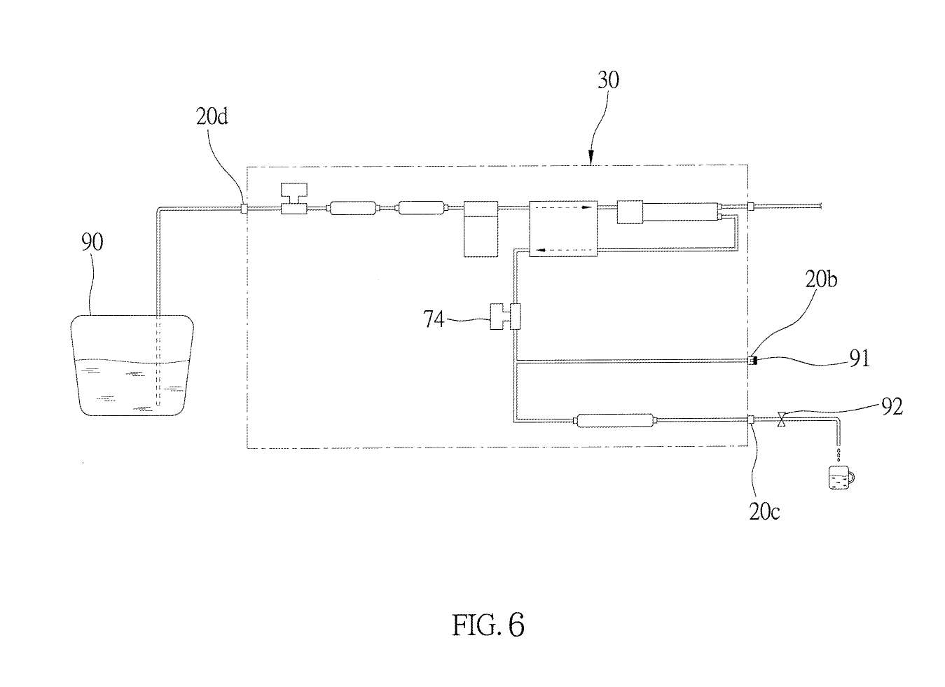

As shown in FIG. 6, when the water filtering apparatus of the present invention is disconnected to the tap water, and connected to an outdoor water source 90, such as a river, through the raw water inlet 20d, a plug 92 is inserted into the filtered water outlet 20b to seal it, and the band switch 70 is switched to the first mode. At this time, the pump 40 is running under a control of the time switch 72 to filter the river water in a predetermined period, and the drinking water could come out from the drinking water outlet 20c by opening the valve 92. The pump 40 would be stopped when the high-pressure sensing switch 74 senses a water pressure higher than the upper-limited pressure.

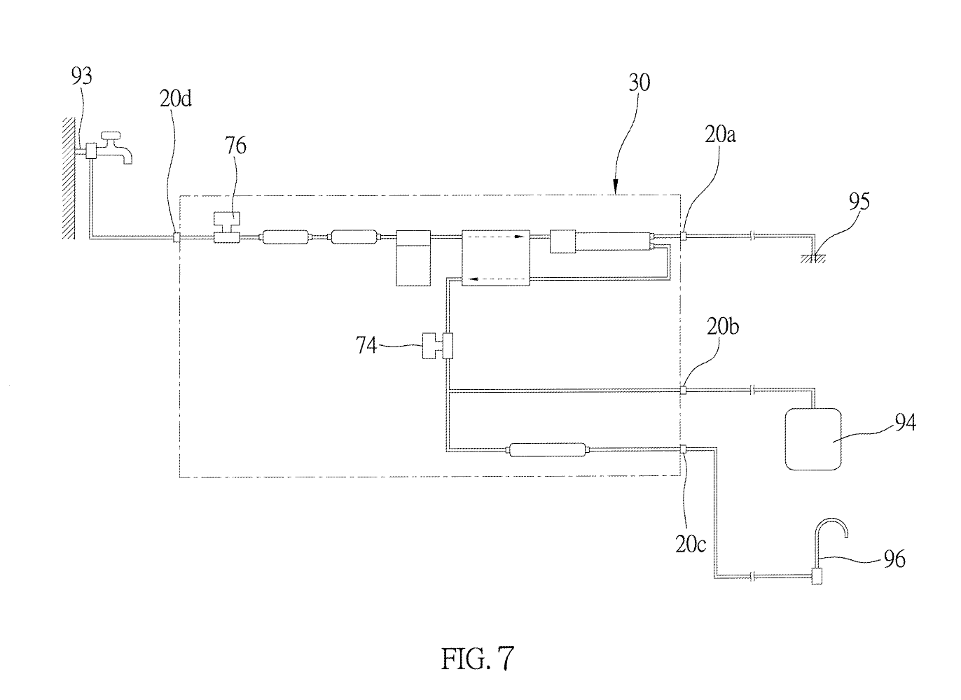

As shown in FIG. 7, when the raw water inlet 20d is connected to a tap water 93, the filtered water outlet 20b is connected to a container 94, the waste water outlet 20a is connected to a waste water pipe 95, the drinking water outlet 20c is connected to a faucet 96, and the band switch 70 is switched to the third mode, the pump 40 is running under a control of both the high-pressure sensing switch 74 and the low-pressure sensing switch 76. When the tap water 93 does not supply enough water, the low-pressure sensing switch 76 will sense a water pressure lower than the lower-limited pressure, and the pump 40 will be stopped to protect the pump 40. When the container 94 is full, the high-pressure sensing switch 74 senses a water pressure higher than the upper-limited pressure, and the pump 40 will be stopped to stop filtering water.

The water filtering apparatus of the present invention would be turned off when the band switch 70 is switched to the second mode no matter the apparatus is used at indoors or at outdoors.

In conclusion, when the user is taking an outdoor activity, the water filtering apparatus of the present invention could filter water from any water source he/she could find, such as river or pond. Therefore, people didn't have to carry any water bottle. When the water filtering apparatus is installed at home, it could filter water from the tap water. If there is a power blackout or shortage, the water filtering apparatus of the present invention would keep working with the electric power of the rechargeable battery 50. It could connect to a battery of a vehicle or a solar battery to supply power as well for the backup power.

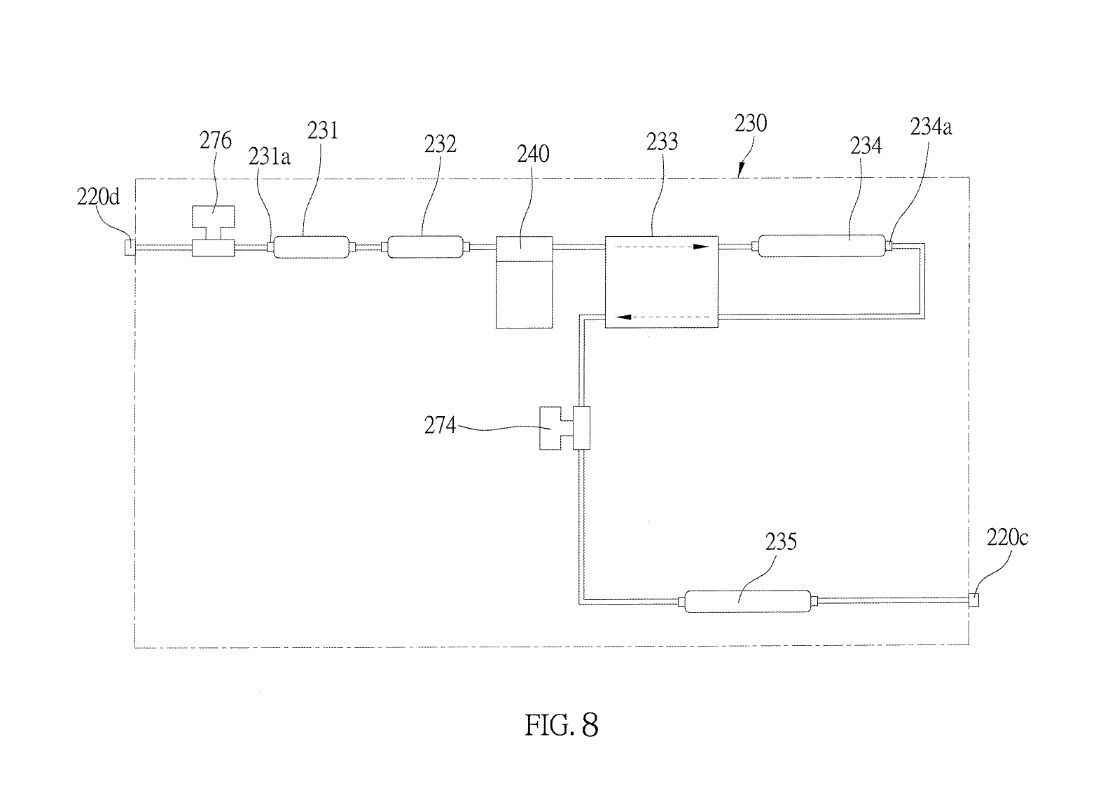

FIG. 8 shows a water filtering apparatus of the second preferred embodiment of the present invention, which is the same as the first embodiment, including a housing 10, a frame, on which a filtering device, a pump, a rechargeable battery, a power device, a switch, a timer, a high-pressure sensing switch, a low-pressure sensing switch, and a displace circuit.

The different part of the water filtering apparatus of the second preferred embodiment is that the filtering device 230 includes a first front filter 231, a second front 232, a water switch 233, a hollow fiber membrane filter 234, and an activated carbon filter 235.

The same as above, the pump 240 pumps raw water through the raw water inlet 220d to be filtered by the first and the second front filters 231, 232, and then water is sent to the hollow fiber membrane filter 234 through the water switch 233 and the pump 240 in sequence to be filtered. The hollow fiber membrane filter 234 has a water outlet 234a to output filtered water, and then the filtered water is sent to activated carbon filter 235 through the water switch 233. At last, the filtered water comes out through the drinking water outlet 220c. The low-pressure sensing switch 276 is provided on a pipe between the first front filter 231 and the raw water inlet 220d to sense a pressure of the water entering the first front filter 231. The high-pressure sensing switch 274 is provided on a pipe between the hollow fiber membrane filter 234 and the drinking water outlet 220c to sense a pressure of the filtered water coming out of the hollow fiber membrane filter 234. The function and operation of the second preferred embodiment is the same as the first preferred embodiment. The use of hollow fiber membrane filter 234 instead of the RO filter makes the filtering faster and need no waste water outlet and the container.

The filter device of the present invention could be provided with only one filter, or three, four, five, or more filters of various types based on the requirements, such as size, weight, and so on.

It must be pointed out that the embodiments described above are only some preferred embodiments of the present invention. All equivalent structures which employ the concepts disclosed in this specification and the appended claims should fall within the scope of the present invention.

1. An indoor and outdoor water filtering apparatus, which is connected to a water source to filter raw water of the water source, and is selectively connected to an external power source, comprising:
a frame;
a filtering device having a raw water inlet, a filtered water outlet, and at least one filter, which is mounted on the frame, wherein the raw water inlet is connected to a water source, and the at least one filter is connected to the raw water inlet and the filtered water outlet respectively to filter raw water of the water source coming in from the raw water inlet, and generates filtered water coming out via the filtered water outlet;
a pump pumping the raw water of the water source to the filter of the filter device;
a rechargeable battery;
a power device including a first power input port, a second power input port, and a power output port, wherein the first power input port is electrically connected to the rechargeable battery, and the second power input port is connected to an external power source, and the power output port is electrically connected to the pump; wherein the power device receives electric power either from the rechargeable battery or the external power source to the power output port;
a first pressure sensor electrically connected to the pump and the power output port of the power device, wherein the first pressure sensor senses a pressure of the filter water coming out of the filter device and the first pressure sensor cuts off the electric power for the pump when the pressure of the filter water coming out of the filter device is higher than an upper-threshold pressure;
a second pressure sensor electrically connected to the pump and the power output port of the power device, wherein the second pressure sensor senses a pressure of the raw water pumped into the filter device and the second pressure sensor cuts off the electric power for the pump when the pressure of the raw water pumped into the filter device is lower than a lower-threshold pressure;
a switch electrically connected to the power output port of the power device, the pump, the first pressure sensor, and the second pressure sensor, wherein the switch has a plurality of operating modes for a user to select, comprising a first mode, a second mode, and a third mode; and
a timer electrically connected to the power device to transmit the electric power from the power device to the pump in a predetermined period, and cut the electric power off when time is up;
wherein the power output port, the pump, the first pressure sensor, the timer, and the switch are electrically connected to form a first loop when the first mode is selected; the electric power for the pump is cut off when the second mode is selected; and the power output port, the pump, the first pressure sensor, the second pressure sensor, and the switch are electrically connected to form a second loop when the third mode is selected;
whereby when the first mode is selected, the timer is set to turn the pump on in the predetermined period, and cuts off the electric power for the pump when time is up; the first pressure sensor senses the pressure of the filter water coming out of the filter device to determine whether to cut off the electric power for the pump;
when the third mode is selected, the first pressure sensor and the second pressure sensor respectively sense the pressure of the filter water coming out of the filter device and the pressure of the raw water pumped into the filter device to determine whether to cut off the electric power for the pump.

2. The indoor and outdoor water filtering apparatus of claim 1, wherein when the external power supplies insufficient electric power to the power device, the pump is powered by both the rechargeable battery and the external power.

3. (canceled)

4. (canceled)

5. The indoor and outdoor water filtering apparatus of claim 1, wherein the at least one filter includes a RO filter.

6. The indoor and outdoor water filtering apparatus of claim 1, wherein the at least one filter includes a hollow fiber membrane filter.

7. (canceled)

8. The indoor and outdoor water filtering apparatus of claim 1, wherein the frame is provided with a grip for a user to hold.
